(19) United States
(12) Patent Application Publication
(10) Pub. No.: US 2011/0018346 A1
(43) Pub. Date: Jan. 27, 2011

(54) Location-Based Power Profiles

(76) Inventor: Ryan G. Dixon, San Francisco, CA (US)

Correspondence Address: TI Law Group, 2055 Junction Avenue, #205, San Jose, CA, 95131-2116, US

(21) Appl. No.: 12/510,131

(22) Filed: Jul. 27, 2009

(51) Int. Cl. H02J 1/00

(52) U.S. Cl. 307/39

(57) ABSTRACT

Power management of an electronic device based upon the location of the electronic device is disclosed. In one embodiment, an electronic device can have at least one power consumption component and a processor configured to: i) create at least one location marker, the at least one location marker representing a reference location; ii) associate the at least one location marker to a power profile, the power profile having utilization instructions for the at least one power consumption component; and iii) automatically manage utilization of the at least one power consumption component in accordance with the power profile when it is determined that the portable electronic device is located at the reference location corresponding to the location marker associated with the power profile.

### FIELD OF THE INVENTION

The present disclosure relates generally to electronic devices and, more particularly, to managing power consumption of electronic devices based on the location of the electronic devices.

### BACKGROUND OF THE INVENTION

Today, users of electronic devices are highly mobile individuals. Whether on business trips, on vacations, or coming to and from work, these individuals are readily identifiable by their use of laptop computers, enhanced-functionality mobile telephones, iPhone™, Palm Pilot™, Blackberry™, and other portable electronic devices. Due to the portable nature of the electronic devices, power consumption can limit their capabilities. Power consumption is generally a minor issue in an operating environment where a user has “plugged” the electronic device into an electrical power outlet or has docked the electronic device into a docking station. In these situations, an external power source provides constant and substantially unlimited power for operating the electronic device, thereby eliminating the need for the electronic device to consume power from an internal power source, such as an internal battery, while plugged in.

If operated in a full power mode using power from the internal battery, the electronic device can typically operate for only a few hours before the battery is drained. In fact, many different software services, software applications, and hardware can run concurrently in the full power mode using various subsystems and components in the electronic device. A display, disk drive, processor (especially a graphics processor), global position system (GPS), and networking products (e.g., Bluetooth® and Wi-Fi™) are some of the components of an electronic device that can run concurrently, yet consume a substantial amount of power. To help reduce power consumption, especially when a stationary power supply is unavailable, many electronic devices include a “standby” mode in which the electronic device turns OFF and/or substantially reduces power to all of its subsystems and components. In such a standby mode, a user generally cannot use any applications unless the electronic device is switched from the standby mode to the full power mode. As such, it can often be necessary for the user to make only limited and very efficient use of the electronic device while it is in full power mode when there are no available stationary power supplies. Furthermore, it may even be necessary for the user to keep the electronic device completely turned off or in a substantially non-functional standby mode as much as possible.

If the user fails to diligently conserve power in this manner, then the electronic device will run out of power and become unusable until the user can recharge or replace the internal battery and/or connect to a stationary power supply. Moreover, as portable electronic devices become more advanced with various options and features, battery charge can be rapidly consumed without users being aware. Thus, there is a need for improved approaches to conserve power for electronic devices.

### SUMMARY

Power management of an electronic device based upon the location of the electronic device is disclosed. In one embodiment, an electronic device can have at least one power consumption component and a processor configured to: i) create at least one location marker, the at least one location marker representing a reference location; ii) associate the at least one location marker to a power profile, the power profile having utilization instructions for the at least one power consumption component; and iii) automatically manage utilization of the at least one power consumption component in accordance with the power profile when it is determined that the portable electronic device is located at the reference location corresponding to the location marker associated with the power profile.

In another embodiment, a method to conserve power consumption on a portable electronic device provides for determining a location of the portable electronic device, retrieving a power profile based on the determined location of the portable electronic device, the power profile stored on the portable electronic device, and automatically configuring the portable electronic device based on the power profile.

In yet another embodiment, a method to conserve power consumption on a portable electronic device can include creating at least one location marker, the at least one location marker representing a reference location. A plurality of power consumption components of the portable electronic device can be listed on a display of the portable electronic device. At least one input to configure at least one power consumption component listed on the display can be received at the portable electronic device. A power profile based on the received at least one input can be created and the power profile may be associated with the at least one location marker. The portable electronic device can be automatically configured based on the power profile when it is determined that the portable electronic device is located at the reference location associated with the location marker.

In still another embodiment a computer readable medium can include at least computer program code stored thereon for conserving power consumption on a portable electronic device for obtaining a location of the portable electronic device, computer program code for retrieving a power profile based on the determined location of the portable electronic device, the power profile stored on the portable electronic device, and computer program code for automatically configuring the portable electronic device based on the power profile.

The present invention provides other hardware configured to perform the methods of the invention, as well as software stored in a machine-readable medium (e.g., a tangible storage medium) to control devices to perform these methods. These and other features will be presented in more detail in the following detailed description of the invention and the associated figures.

### BRIEF DESCRIPTION OF THE DRAWINGS

The invention will be readily understood by the following detailed description in conjunction with the accompanying drawings, and in which:

FIG. 1 is a block diagram of one embodiment of an electronic device.

FIG. 2 is an example graphical user interface presented on a display of the electronic device.

FIGS. 3A-3C illustrate example power profiles.

FIG. 4 is a flow diagram illustrating one embodiment to create a power profile.

FIG. 5 is a flow diagram illustrating one embodiment to manage battery consumption of the electronic device according to one embodiment.

### DESCRIPTION OF EXAMPLE EMBODIMENTS

Embodiments are described herein in the context of location-based power profiles. The following detailed description is illustrative only and is not intended to be in any way limiting. Other embodiments will readily suggest themselves to such skilled persons having the benefit of this disclosure. Reference will now be made in detail to implementations as illustrated in the accompanying drawings. The same reference indicators will be used throughout the drawings and the following detailed description to refer to the same or like parts.

It will, of course, be appreciated that in the development of any such actual implementation, numerous implementation-specific decisions must be made in order to achieve a developer's specific goals, such as compliance with application- and business-related constraints, and that these specific goals will vary from one implementation to another and from one developer to another.

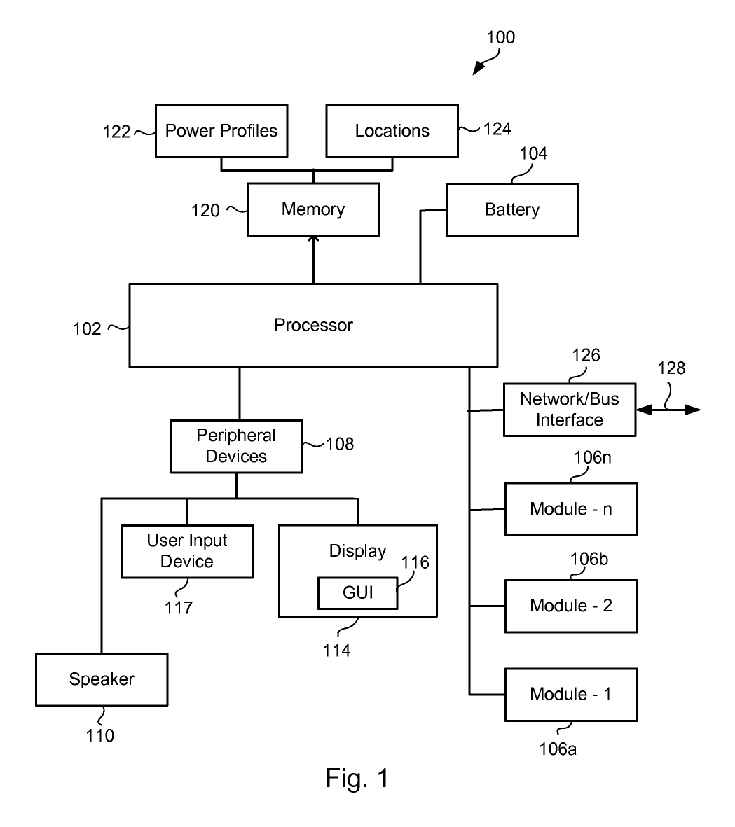

Power management of an electronic device based upon the location of the electronic device is disclosed. FIG. 1 is a block diagram of one embodiment of an electronic device. Device 100 is typically a portable or mobile electronic device. Device 100 can pertain to a computing device, a media player, a mobile telephone, a portable game player, portable workout manager, and the like. In one embodiment, device 100 is a multi-functional device that supports a plurality of different functions. As one example, device 100 can be portable and operate as a mobile telephone while also operating as a media player. In another example, the device 100 can operate as a mobile telephone while also operating as a global positioning system (GPS).

Device 100 can include processor 102 that controls the overall operation of device 100 as well as monitor current use of device 100. In addition, device 100 can include battery 104 that provides power to each of the power consumption components of device 100. Typically, battery 104 is rechargeable by coupling battery 104 to an Alternating Current (AC) outlet to allow a charge circuit (not shown) to charge battery 104. Although device 100 is powered by battery 104, in one embodiment, device 100 can also at times utilize power supplied via a power cord coupled to an AC plug. The AC power is also used to charge battery 104. The power consumption components may be any component on device 100 which consumes battery power. The power consumption components can, for example, pertain to modules or devices within or coupled to device 100. Examples of power consumption components can, for example, include any peripheral devices, locator device (e.g., wireless locator device), network access devices (e.g., wireless network access device), or any other services or features that utilize battery power.

Processor 102 can also communicate with one or more modules 106a-n (where n is an integer), which can be hardware and/or software components (including software applications), within device 100. For example, the modules can include first module module-1 106a, second module-2 106b, . . . , and nth-module module-n 106n. The different modules can pertain to different functions or capabilities that can be supported by device 100.

As an example, first module 106a can pertain to a GPS subsystem. The GPS subsystem may be used to determine the location of the device 100, determine a location to be associated with a power profile 122, or assist a user in reaching a specified location.

In another example, second module 106b can pertain to a short range wireless network, such as BLUETOOTH®. Using radio waves, BLUETOOTH® is widely used for hands-free conversations in mobile telephones.

In still another example, the nth-module 106n can pertain to a wireless communication network module. The wireless communication network module 106n can provide voice communications (e.g., calls via a cellular network) as well as data communications.

Processor 102 can also communicate with a network/bus interface 126. The network/bus interface 126 can also be considered another module. In one embodiment, the network/bus interface 126 can also be considered to provide data communications. The network/bus interface 126 can also couple to data link 128. Data link 128 can allow device 100 to couple to a host computer (not shown) over a wired connection.

Device 100 can also include one or more peripheral devices 108. The peripheral devices may be any devices used to carry out the functions and/or features for the device 100. For example, a peripheral device may be a speaker 110 for audio output. Another peripheral device may be a display 114. Display 114 that can be controlled by processor 102 to display information to the user. As appropriate, graphical user interface (GUI) 116 can present on display 114 a dialog window in which a user can create a power profile or modify an existing power profile.

In another example, the peripheral device may be a user input device 117. The user input device 117 can assist a user in providing user input, such as by interacting with GUI 116. User input device 117 can pertain to one or more input buttons, touch-sensitive surfaces, roller balls, keyboard, and the like that enable the user to provide user input, such as user selections for the power profile and interact with device 100. The user input device 117 can be programmed to be individually or in combination perform any of a suite of functions. In one implementation, user input device 117 can be provided by a dial that physically rotates. In another implementation, user input device 117 can be implemented as a touch pad (i.e., a touch-sensitive surface). In still another implementation, user input device 117 can be implemented as a combination of one or more physical buttons as well as a touch pad.

The device 100 may also have a memory 120 to communicate with processor 102. The memory 120 may be any known memory 120 such as a random-access memory (RAM), read-only memory (ROM), or other similar memories. The memory 120 can store programs, utilities or processes to be executed, power profiles 122, and current and/or previous locations 124 of device 100.

However, use of the modules 106a-n, peripheral device 108, and other components of the device 100 may require battery power consumption. Furthermore, concurrent usage of the components may use a substantial amount of power from battery 104, thereby causing it to become depleted rather quickly.

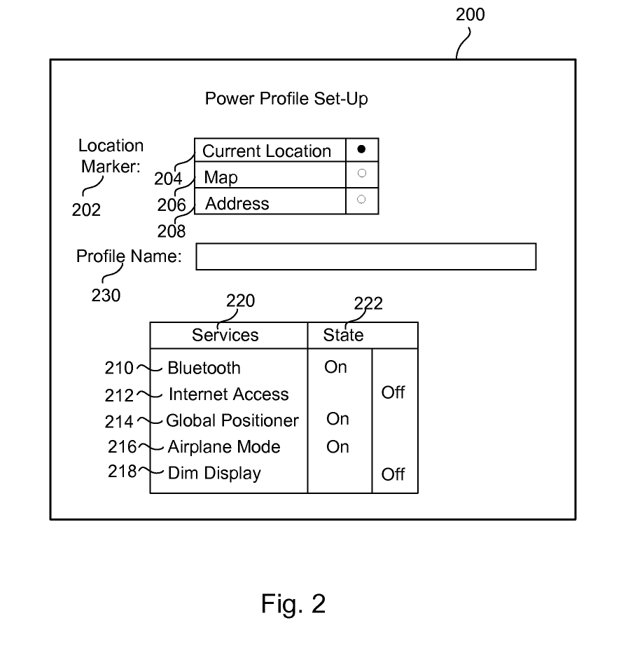

FIG. 2 is an example graphical user interface (GUI) 200 presented on a display of an electronic device according to one embodiment of the invention. GUI 200 enables a user to create or set-up the power profiles. Using GUI 200, a user can interact with the electronic device 100 to set-up the power profiles with respect to the different locations the device 100 may be used at. A location marker 202 may be used to reference or define a location for the power profile. The location marker 202 may be a specified point of location or an area. For example, the location may be a pre-defined or specific address such as “1234 Nowhere Street, San Jose, Calif.”. In another example, the location may reference or define an area by a zip code, county, or city.

In one embodiment, the location marker 202 may be selected based upon the current location 204 of device 100. Current location 204 may be determined by a position determination module, such as a locator module. The locator module can be a locator device, such as a GPS subsystem. The locator module can also determine position with assistance from a wireless network (e.g., network triangulation, geographic WiFi hotspot, etc.)

In another embodiment, the user may use a map input 206 to select a location or area for the location marker 202. A map may be displayed on display 200 to allow user to select a specific location or area on the map. In still another embodiment, the user may input a specific address 208 for location marker 202.

In creating the power profile, the user may input a profile name 230. For example, if the location 202 is at the user's home, the power profile may be named “Home”. In another example, if the location 202 is at the user's office, the power profile may be “Office”. In still another example, the profile name 230 may be a “Default” profile, as further described below.

A user may customize different power profiles to use different services 220 when the electronic device is at different locations. For example, the services 220 can include BLUETOOTH® 210, a wireless network 212 (“Internet Access”), locator device 214 (“Global Positioner”), various mobile telephone modes 216 (“Airplane Mode”), peripheral device usage 218 (“Dim Display”), or any other services. For each power profile, the user can set the states 222 to be applied. Namely, the user may select the states 222 for each of the services 220. As illustrated in FIG. 2, for example, the states 222 that have been selected for the particular power profile indicate: BLUETOOTH® 210, Global Positioner 214, and Airplane Mode are set to ON, and Internet Access and Dim Display are set to OFF.

Advantageously, available battery power can be preserved by turning off functions of the device that a user does not need to use at pre-defined locations. In other words, usage of battery power can be reduced by turning off various functions of the device. Furthermore, creating power profiles provides for a more efficient use of the device whereby the various functions may be automatically turned on or off based upon different locations. A user would therefore not be required to manually turn on or off each function, which allows for a more power efficient use of device.

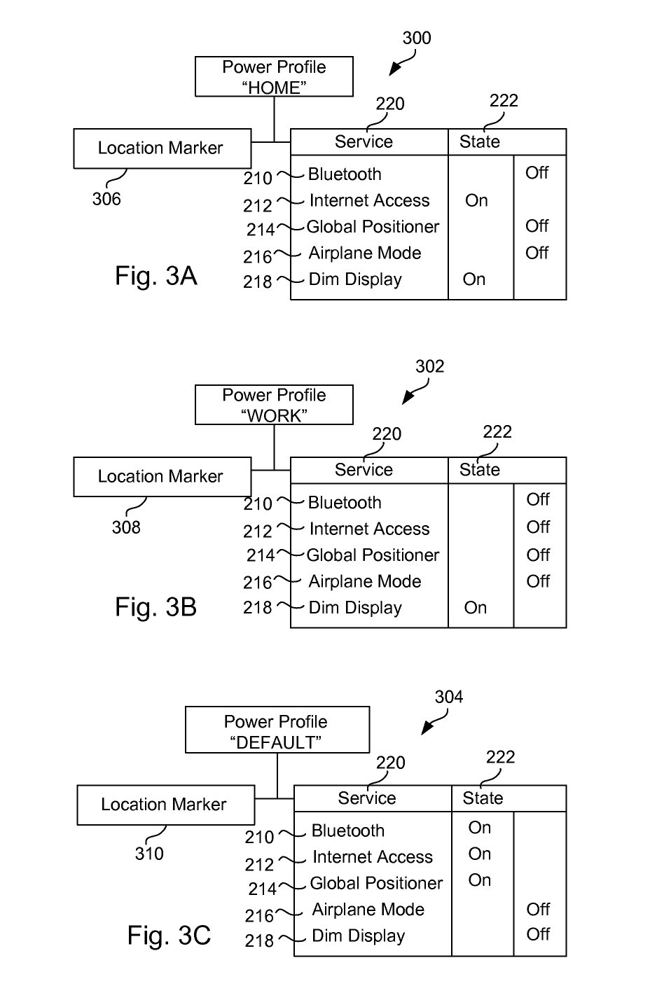

FIGS. 3A-3C illustrate example power profiles. Power profiles may include instructions to disable or enable power consumption components on the device. In use, in one example as illustrated in FIG. 3A, a user may set up a power profile “HOME” for when the device is located at the user's home. The location marker 306 associated with power profile “HOME” may be the user's home address. When at home, the user may not want to use the BLUETOOTH® 210, global positioner 214, or airplane mode 216. Thus, the state 222 of each of those may be “OFF” (i.e., enabled). However, the user may want to have internet access 212 and the display dimmed 218. Thus, the state 222 of each of those may be set to “ON” (i.e., disabled).

FIG. 3B illustrates an example power profile for when the device is located at the office or when the user is at work. The location marker 308 may be set to the location or address of the user's office and associated with the “WORK” power profile 302. When at the office, the user may use the office phone and computer and thus not need to use the BLUETOOTH® 210, internet access 212, global positioner 214, or airplane mode 216. The state 222 of each of those may be set to “OFF”. However, the user may want to dim the display 218 and set the state to “ON”.

In one embodiment, the power profile may be associated with a plurality of location markers. For example, the user may have more than one work location marker to associate the “WORK” power profile. The user may have a field office as well as a physical office. In another example, the user may have multiple offices, such as a contractor with multiple clients. In yet another example, the user may have a second home to associate the “HOME” power profile.

FIG. 3C illustrates an example default power profile. When a location of the device is not associated with any power profile, the “DEFAULT” power profile 304 may be used. In one embodiment, the user may be roaming and/or at a location that is not associated with any power profile. Thus, no location may be stored in the location marker 310. When roaming, a user may want to use BLUETOOTH® 210, internet access 212, and the global positioner 214—all of which may be set to the “ON” state. Airplane mode 216 and dim display 218 may be set to the “OFF” state. In one embodiment, the device can be initially configured such that a default profile is presented. The user can thereafter alter the default profile to their preferences. For example, the default profile might initially have all services 220 “ON” or enabled.

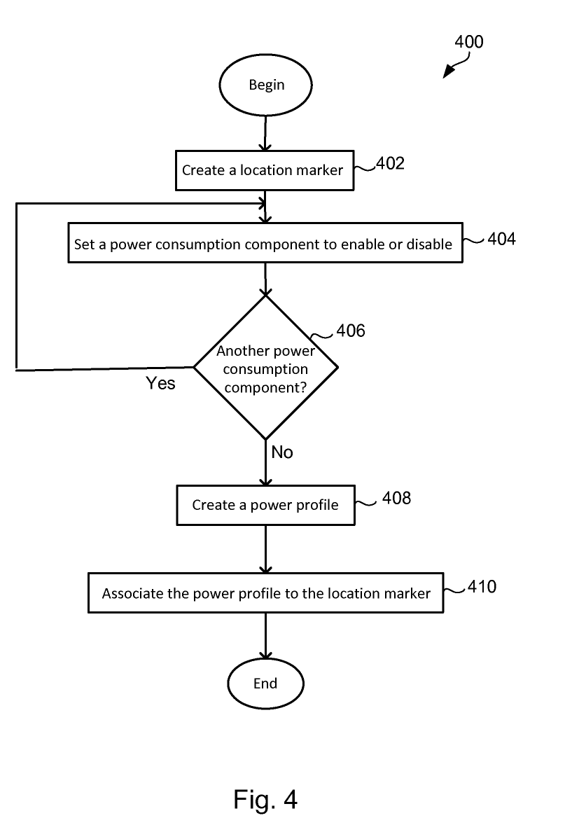

FIG. 4 is a flow diagram illustrating one embodiment to create a power profile. The method for creating the power profile 400 starts with creating a location marker at 402. The location marker may be used to reference or define a location for the power profile. The location marker may be a specified point of location or an area. For example, the location may be a pre-defined or specific address such as “1234 Nowhere Street, San Jose, Calif.”. In another example, the location may reference or define an area such as a zip code, county, or city.

In one embodiment, the location marker may be selected based upon the current location of the device. The current location 204 may be determined by a GPS or any locator module on the device. In another embodiment, the user may use a map to select a location for the location marker. The map may be displayed on a display of device to allow user to select a specific location or area on the map. In still another embodiment, the user may input a specific address for the location marker.

Furthermore, in one embodiment, a plurality of location markers may be created. For example, the user may have more than one work location to set as the location marker for a “WORK” power profile. In another example, the user may have more than one home address to set the location marker for a “HOME” power profile.

A user may set a power consumption component to be enabled or disabled at 404. In one embodiment, a list of power consumption components may be displayed on a display of the device. The power consumption components may be any component on device which consumes battery power such as any peripheral devices, wireless locator device, wireless network access, or any other services or features that utilize battery power. For example, power consumption components may be use of the BLUETOOTH® capability, wireless internet access, GPS, display features, and the like. If a user desires use of certain the power consumption components at the location of the created location marker, the state of the power consumption components may be set to “ON” or enabled. If the power consumption components are not used at the location of the created location marker, the power consumption component may be set to the “OFF” or disabled state.

The user can continue to set each power consumption component to enable or disable if there are more power consumption components at 406. If there are no more power consumption components to set at 406, the power profile may be created at 408. When creating the power profile, the user may set a profile name for the power profile. For example, if the power profile is to be used when the device is located at the user's home, the power profile may be named “Home”. In another example, if the power profile is to be used when the device is located at the user's office or work location the power profile may be called “Office” power profile. In still another example, when the location of the device is undetermined or not associated with a power profile, the profile may be named “Default” profile.

The created power profile may then be associated with the location marker at 410. When it is subsequently determined that the device is located at a location created for the location marker, the power consumption components on the device will automatically be enabled or disabled based upon the appropriate power profile.

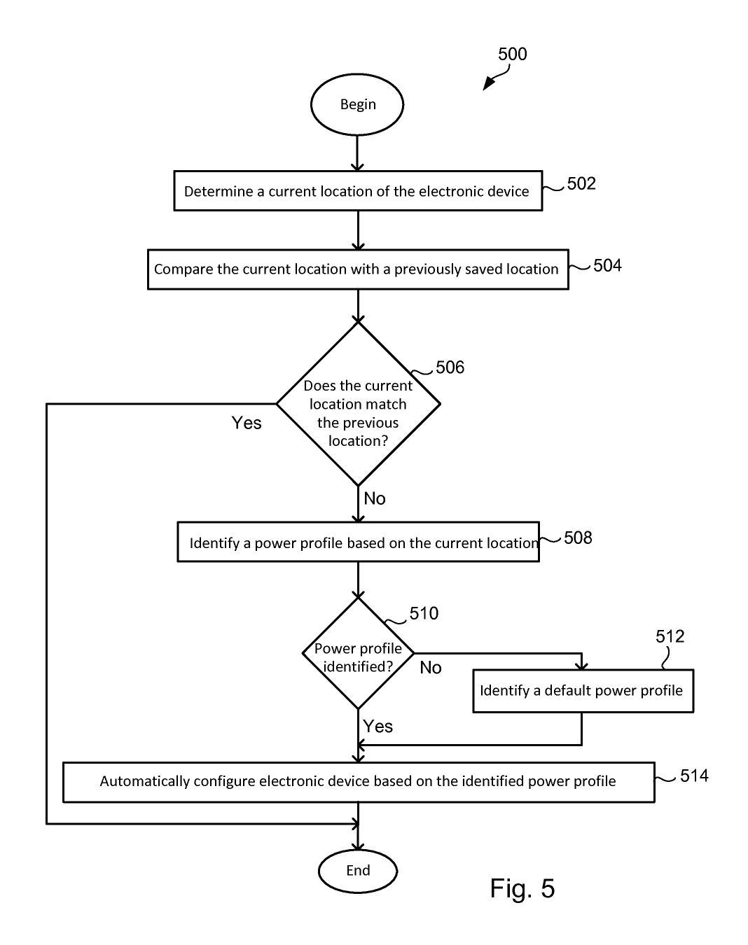

FIG. 5 is a flow diagram illustrating one embodiment to manage battery consumption of the electronic device according to one embodiment. The method to manage battery consumption 500 starts with determining a current location of the electronic device at 502. The location of the device may be determined with a wireless locator device on the electronic device, such as a GPS. In another embodiment, the location of device can be determined using known wireless mobile telephone features, such as cellular triangulation.

Since the wireless locator device is a power consumption component, in certain embodiments the wireless locator device may be disabled. Thus, processor may enable the wireless locator device at predetermined time intervals, such as every hour, to determine whether the device has been moved from a previous location.

A current location of the device may be compared to the previous location of device at 504. If the device was not moved from the previous location, the current location will match the previous location at 506 and no power profile needs to be identified. If the current location does not match the previous location at 506, a power profile can be identified based on the current location at 508. The current location can be matched against a location of each location marker for each power profile. If no matches are found and no power profile identified at 510, a default power profile may be identified at 512.

Regardless of whether a power profile was identified at 510 or if the default power profile was identified at 512, the device can be automatically configured based on the identified power profile at 514. The identified power profile and/or default power profile may be similar to the example power profiles and default power profile as discussed above with reference to FIGS. 3A-3C.

In one embodiment, the invention is suitable for use with a portable electronic device having at least wireless voice communication capability and/or media playback capability. The portable electronic device can, for example, be a portable media device (e.g., digital music player or MP3 player) having wireless voice communications. In another embodiment, the portable electronic device can be a wireless communications device (e.g., mobile telephone) having media playback capabilities. In still another embodiment, the portable electronic device can be a portable electronic device having media playback capability. These portable electronic devices can also have other functions (e.g., applications), such as functions supporting electronic calendars, electronic appointments, network browsers, games, network data transfers, VoIP applications, and the like.

In another embodiment, the electronic device is a portable electronic device. In one implementation, the portable electronic device is a handheld electronic device. Often, portable electronic devices are handheld electronic devices that can be easily held by and within a single hand of a user. The portable electronic device can also pertain to a wearable electronic device or a miniature electronic device. However, the invention can apply to electronic devices whether portable or not.

Different aspects, embodiments or implementations can operate to automatically manage power consumption of a electronic device based upon the location of the device. Furthermore, the management of power consumption can occur automatically without requiring manual intervention by the user. Such automatic management of power consumption enables reduced power consumption by electronic devices and prolonged usage under battery power.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention. It will, of course, be appreciated that in the development of any such actual implementation, numerous implementation-specific decisions must be made in order to achieve a developer's specific goals, such as compliance with application- and business-related constraints, and that these specific goals will vary from one implementation to another and from one developer to another.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A portable electronic device, comprising:
at least one power consumption component; and
a processor configured to:
i) create at least one location marker, the at least one location marker representing a reference location;
ii) associate the at least one location marker to a power profile, the power profile having utilization instructions for the at least one power consumption component; and
iii) automatically manage utilization of the at least one power consumption component in accordance with the power profile when it is determined that the portable electronic device is located at the reference location corresponding to the location marker associated with the power profile.

2. The device of claim 1, wherein the power profile comprises instructions to enable or disable the at least one power consumption component.

3. The device of claim 2, wherein the portable electronic device stores a plurality of different power profiles each associated with different location markers representing different reference locations.

4. The device of claim 1, further comprising a memory coupled to the processor, the memory configured to store the power profile.

5. The device of claim 1, wherein the processor is further configured to:
i) enable a wireless locator device on the portable electronic device if it is determined to be deactivated;
ii) use the wireless locator device to determine the location of the portable electronic device.

6. The device of claim 1, wherein the at least one power consumption component is selected from the group consisting of a wireless locator device, a wireless network access, and a peripheral device.

7. A method to conserve power consumption on a portable electronic device, comprising:
determining a location of the portable electronic device;
retrieving a power profile based on the determined location of the portable electronic device, the power profile stored on the portable electronic device; and
automatically configuring the portable electronic device based on the power profile.

8. The method of claim 7, the automatic configuring comprising:
automatically activating or deactivating at least one power consumption component of the portable electronic device in accordance with the power profile.

9. The method of claim 7, wherein the method further comprises:
creating a power profile;
storing the power profile on the portable electronic device;
creating at least one location marker, the at least one location marker representing a pre-determined location; and
associating the at least one location marker with the power profile.

10. The method of claim 9, wherein the retrieving a power profile comprises:
determining whether the determined location matches at least one location marker; and
retrieving the power profile corresponding with the at least one location marker that is determined to match the determined location.

11. The method of claim 10, wherein the retrieving a power profile further comprises:
retrieving a default power profile if the determined location does not match the at least one location marker.

12. The method of claim 7, wherein the determining a location further comprises:
determining if a wireless locator device on the portable electronic device is activated;
enabling a wireless locator device on the portable electronic device if it is determined to be deactivated; and
using the wireless locator device to determine the location of the portable electronic device.

13. The method of claim 7, wherein the at least one power consumption component is selected from the group consisting of a wireless locator device, a wireless network access, and a peripheral device.

14. A method to conserve power consumption on a portable electronic device, comprising:
creating at least one location marker, the at least one location marker representing a reference location;
listing a plurality of power consumption components of the portable electronic device on a display of the portable electronic device;
receiving, at the portable electronic device, at least one input to configure at least one power consumption component listed on the display;
creating a power profile based on the received at least one input;
associating the power profile to the at least one location marker; and
automatically configuring the portable electronic device based on the power profile when it is determined that the portable electronic device is located at the reference location associated with the location marker.

15. The method of claim 14, wherein the automatically configuring comprises:
disabling at least one of the power consumption components based on the power profile.

16. The method of claim 15, wherein the automatically configuring comprises:
enabling another of the power consumption components based on the power profile.

17. The method of claim 14, further comprising:
determining a location of the portable electronic device;
identifying a power profile having an associated location marker that matches the determined location; and.
automatically disabling at least one power consumption component based on the identified power profile.

18. A computer readable medium including at least computer program code stored thereon for conserving power consumption on a portable electronic device, comprising:
computer program code for obtaining a location of the portable electronic device;
computer program code for retrieving a power profile based on the determined location of the portable electronic device, the power profile stored on the portable electronic device; and
computer program code for automatically configuring the portable electronic device based on the power profile.
